(19) United States
(12) Patent Application Publication
(10) Pub. No.: US 2022/0285059 A1
(43) Pub. Date: Sep. 8, 2022

(54) NEODYMIUM-IRON-BORON MAGNET MATERIAL, RAW MATERIAL COMPOSITION, PREPARATION METHOD THEREFOR AND USE THEREOF

(71) Applicants: XIAMEN TUNGSTEN CO., LTD., Fujian (CN); FUJIAN CHANGTING GOLDEN DRAGON RARE-EARTH CO., LTD, Fujian (CN)

(72) Inventors: Gang FU, Fujian (CN); Jiaying HUANG, Fujian (CN); Jixiang HUANG, Fujian (CN); Qichen QUAN, Fujian (CN)

(21) Appl. No.: 17/600,105

(22) PCT Filed: Jul. 7, 2020
(86) PCT No.: PCT/CN2020/100587

§ 371 Date: Sep. 30, 2021

(30) Foreign Application Priority Data
Nov. 21, 2019 (CN) 201911150975.1

(51) Int. Cl. H01F 1/057; H01F 41/02

(52) U.S. Cl. CPC H01F 1/0577; H01F 41/0266; H01F 1/0573

(57) ABSTRACT

Disclosed are a neodymium-iron-boron magnet material, a raw material composition and a preparation method therefor and a use thereof. The raw material composition of the neodymium-iron-boron magnet material comprises the following components by mass percentage: 29.5-32% of R′, wherein R′ is a rare earth element and includes Pr and Nd; and Pr≥17.15%; Cu≥0.35%; 0.9-1.2% of B; 64-69.2% of Fe. The percentages refer to the mass percentages relative to the total mass of the raw material composition of the neodymium-iron-boron magnet material. Without the addition of a heavy rare earth element, the neodymium-iron-boron magnet material can still have a high remanence and coercive force.

### TECHNICAL FIELD

The present disclosure relates to a neodymium-iron-boron magnet material, a raw material composition and a preparation method therefor and a use thereof.

### Background

The neodymium-iron-boron (NdFeB) magnet material with Nd₂Fe₁₄B as the main component has high remanence (Br), coercivity and maximum energy product (BHmax) with great comprehensive magnetic properties, and is used in wind power generation, new energy vehicles, inverter household appliances and so on. The rare-earth component of the neodymium-iron-boron magnet material in the prior art is usually dominated by neodymium with only a small amount of praseodymium. Although there are few reports in the prior art that replacing a portion of neodymium with praseodymium can improve the performance of the magnet material, the improvement is limited and still not significant. On the other hand, the neodymium-iron-boron magnet material with good coercivity and remanence properties in the prior art also need to rely on the addition of large amounts of heavy rare earth elements and the cost is relatively expensive.

### CONTENT OF THE PRESENT INVENTION

The technical problem to be solved in the present disclosure is for overcoming the defect that the coercivity and remanence of the magnet material cannot be significantly improved after the neodymium is replaced with the praseodymium partially in the neodymium-iron-boron magnet material in the prior art. A neodymium-iron-boron magnet material, a raw material composition and a preparation method therefor and a use thereof are provided. The content of praseodymium and copper in the neodymium-iron-boron magnet material of the present invention are increased at the same time, which can overcome the defect in the prior art in that the coercivity of the neodymium-iron-boron magnet material cannot be significantly improved when the content of praseodymium or copper is increased alone, and the remanence and coercivity of the obtained neodymium-iron-boron magnet material are both high.

At present, it is generally believed in the prior art that adding a small amount of copper to the neodymium-iron-boron magnet material can increase wettability. However, the inventors found through extensive experiments that after mating the specific content of praseodymium with the specific content of copper, non-magnetic phases such as RECu₂, RECu and RE₆Fe₃Cu appeared, wherein RE refers to neodymium and praseodymium elements, and the appearance of these non-magnetic phases effectively isolates the magnetic coupling between the crystal grains, and also improves the clarity of grain boundaries and optimizes the grain boundary phases, so that the performance of the neodymium-iron-boron magnet material can be further improved.

The present disclosure solves the above-mentioned technical problems through the following technical solutions:

The present disclosure provides a raw material composition of neodymium-iron-boron magnet material, wherein, the raw material composition of neodymium-iron-boron magnet material comprises the following components by mass percentage:
29.5-32% of R′, R′ is a rare earth element and includes Pr and Nd; wherein, Pr≥17.15%;
Cu≥0.35%;
0.9-1.2% of B;
64-69.2% of Fe, the percentage refers to the mass percentage relative to the total mass of the raw material composition of neodymium-iron-boron magnet material.

In the present disclosure, the content of Pr is preferably 17.15-26%, for example 17.15%, 18.15%, 19.15%, 20.15%, 20.85%, 21.15%, 22.15%, 23.15%, 24.15%, 25.15% or 26%, the percentage refers to the mass percentage relative to the total mass of the raw material composition of neodymium-iron-boron magnet material.

In the present disclosure, the content of Nd is preferably 15% or less, more preferably 4-13%, for example 4%, 5.85%, 6.85%, 7.85%, 8.85%, 9.85%, 10.65%, 10.85%, 11.35%, 12.35% or 12.85%, the percentage refers to the mass percentage relative to the total mass of the raw material composition of neodymium-iron-boron magnet material.

In the present disclosure, the content of R′ is for example 29.5%, 30%, 30.5%, 31%, 31.5% or 32%, the percentage refers to the mass percentage relative to the total mass of the raw material composition of neodymium-iron-boron magnet material.

In the present disclosure, preferably. R′ further comprises other rare earth elements besides Pr and Nd, for example Y.

In the present disclosure, preferably, R′ further comprises RH, RH is heavy rare earth element, the kind of RH preferably comprises one or more of Dy, Tb and Ho, more preferably Dy and/or Tb.

Wherein, the mass ratio of RH and R′ is preferably less than 0.253, more preferably 0-0.07, for example 0, 1/32, 2/32, 2/31, 1.5/32, 2/32 or 1.5/31.

Wherein, the content of RH is preferably 1-2.5%, for example 1%, 1.5% or 2%, the percentage refers to the mass percentage relative to the total mass of the raw material composition of neodymium-iron-boron magnet material.

When RH comprises Tb, the content of Tb is preferably 0.5-2%, for example 0.7%, 0.8%, 0.9%, 1%, 1.5%, 1.8%, 1.9% or 2%, the percentage refers to the mass percentage relative to the total mass of the raw material composition of neodymium-iron-boron magnet material.

When RH comprises Dy, the content of Dy is preferably 1% or less, more preferably 0.3% or less, for example 0.1%, 0.2% or 0.3%, the percentage refers to the mass percentage relative to the total mass of the raw material composition of neodymium-iron-boron magnet material.

When RH comprises Ho, the content of Ho can be the conventional content in the field, for example 0.8-2%, preferably 1%, the percentage refers to the mass percentage relative to the total mass of the raw material composition of neodymium-iron-boron magnet material.

In the present disclosure, the content of Cu is preferably 0.35-1.3%, for example 0.35%, 0.4%, 0.45%, 0.5%, 0.6%, 0.65%, 0.7%, 0.8%, 0.85%, 0.9%, 0.95%, 1%, 1.05%, 1.1% or 1.2%, the percentage refers to the mass percentage relative to the total mass of the raw material composition of neodymium-iron-boron magnet material.

In the present disclosure, the content of B is preferably 0.95-1.2%, for example 0.985%, 1%, 1.1% or 1.2%, the percentage refers to the mass percentage relative to the total mass of the raw material composition of neodymium-iron-boron magnet material.

In the present disclosure, the content of Fe is preferably 64.8-69.2%, for example 64.914%, 64.965%, 65.065%, 65.085%, 65.135%, 65.365%, 65.405%, 65.485%, 65.54%, 65.615%, 65.665%, 65.715%, 65.815%, 65.865%, 65.915%, 66.015%, 66.035%, 66.045%, 66.215%, 66.23%, 66.265%, 66.315%, 66.465%, 66.445%, 66.545%, 66.615%, 66.715%, 66.815%, 66.865%, 67.145%, 67.165%, 67.415%, 67.615%, 67.915%, 68.015%, 68.295%, 68.565% or 69.165%, the percentage refers to the mass percentage relative to the total mass of the raw material composition of neodymium-iron-boron magnet material.

In the present disclosure, preferably, the raw material composition of neodymium-iron-boron magnet material further comprises Al.

Wherein, the content of Al is preferably 3% or less, more preferably 0.5% or less, for example 0.02%, 0.03%, 0.1%, 0.2%, 0.25%, 0.3%, 0.4%, 0.45%, 0.46% or 0.48%, the percentage refers to the mass percentage relative to the total mass of the raw material composition of neodymium-iron-boron magnet material.

In the present disclosure, preferably, the raw material composition of neodymium-iron-boron magnet material further comprises Ga.

Wherein, the content of Ga is preferably 1% or less, more preferably 0.05-0.6%, for example 0.1%, 0.15%, 0.18%, 0.2%, 0.24%, 0.25%, 0.3%, 0.4% or 0.5%, the percentage refers to the mass percentage relative to the total mass of the raw material composition of neodymium-iron-boron magnet material.

In the present disclosure, preferably, the raw material composition of neodymium-iron-boron magnet material further comprises Zr.

Wherein, the content of Zr is preferably 0.3% or less, for example 0.1%, 0.2%, 0.22%, 0.25%, 0.26%, 0.27%, 0.28%, 0.29% or 0.3%, more preferably 0.25-0.3%, the percentage refers to the mass percentage relative to the total mass of the raw material composition of neodymium-iron-boron magnet material.

In the present disclosure, preferably, the raw material composition of neodymium-iron-boron magnet material further comprises Co.

Wherein, the content of Co is preferably 0.2-1.5%, for example 0.2% or 1%, the percentage refers to the mass percentage relative to the total mass of the raw material composition of neodymium-iron-boron magnet material.

In the present disclosure, preferably, the raw material composition of neodymium-iron-boron magnet material can further comprise other conventional elements in the field, for example one or more of Zn, Ag, In, Sn, V, Cr, Mo, Ta, Hf and W.

Wherein, the content of Zn can be a conventional content in the field, preferably 0.1% or less, more preferably 0.04-0.08%, for example 0.04%, 0.05% or 0.08%, the percentage refers to the mass percentage relative to the total mass of the raw material composition of neodymium-iron-boron magnet material.

Wherein, the content of Mo can be a conventional content in the field, preferably 0.1% or less, more preferably 0.01-0.08%, for example 0.04%, 0.05% or 0.08%, the percentage refers to the mass percentage relative to the total mass of the raw material composition of neodymium-iron-boron magnet material.

In the present disclosure, the raw material composition of neodymium-iron-boron magnet material preferably comprises the following components by mass percentage: 29.5-32% of R′. R′ is a rare earth element and includes Pr and Nd; wherein, Pr≥17.15%; Cu≥0.35%; Al≤0.5%; 0.9-1.2% of B; 64-69.2% of Fe; more preferably, the content of Pr is 17.15-26%; more preferably, the content of Cu is preferably 0.35-1.2%; more preferably, R′ further comprises RH, RH is a heavy rare earth element, the content of the heavy rare earth element is preferably 1-2.5%, the percentage refers to the mass percentage relative to the total mass of the raw material composition of neodymium-iron-boron magnet material.

In the present disclosure, the raw material composition of neodymium-iron-boron magnet material preferably comprises the following components by mass percentage: 29.5-32% of R′, R′ is a rare earth element and includes Pr and Nd; wherein, Pr≥17.15%; Cu≥0.35%; 0.5-0.3% of Zr; 0.9-1.2% of B; 64-68% of Fe; more preferably, the content of Pr is 17.15-26%; more preferably, the content of Cu is preferably 0.35-1.2%; more preferably, R′ further comprises RH, RH is a heavy rare earth element, the content of the heavy rare earth element is preferably 1-2.5%, the percentage refers to the mass percentage relative to the total mass of the raw material composition of neodymium-iron-boron magnet material.

In the present disclosure, the raw material composition of neodymium-iron-boron magnet material preferably comprises the following components by mass percentage: 29.5-32% of R′, R′ is a rare earth element and includes Pr and Nd; wherein, Pr≥17.15%; Cu≥0.35%; Al≤0.5%; 0.25-0.3% of Zr; 0.9-1.2% of B; 64-69.2% of Fe; more preferably, the content of Pr is 17.15-26%; more preferably, the content of Cu is preferably 0.35-1.2%; more preferably, R′ further comprises RH, RH is a heavy rare earth element, the content of the heavy rare earth element is preferably 1-2.5%; the kind of RH preferably comprises Dy and/or Tb, wherein, the content of Tb is preferably 0.5-2%, the content of Dy is preferably 1% or less; the percentage refers to the mass percentage relative to the total mass of the raw material composition of neodymium-iron-boron magnet material.

In the present disclosure, the raw material composition of neodymium-iron-boron magnet material preferably comprises the following components by mass percentage: 29.5-32% of R′, R′ is a rare earth element and includes Pr and Nd; wherein, Pr≥17.15%; Cu≥0.35%; Ga≤0.42%; 0.9-1.2% of B; 64-69.2% of Fe; more preferably, the content of Pr is 17.15-26%; more preferably, the content of Cu is preferably 0.35-1.3%; more preferably, R′ further comprises RH, RH is a heavy rare earth element, the content of the heavy rare earth element is preferably 1-2.5%, the percentage refers to the mass percentage relative to the total mass of the raw material composition of neodymium-iron-boron magnet material.

In the present disclosure, the raw material composition of neodymium-iron-boron magnet material comprises the following components by mass percentage: 29.5-32% of R′, R′ is a rare earth element and includes Pr and Nd; wherein, Pr≥17.15%; Cu≥20.35%; Al≤0.5%; Ga≤0.42%; 0.9-1.2% of B; 64-69.2% of Fe; more preferably, the content of Pr is 17.15-26%; more preferably, the content of Cu is 0.35-1.3%; more preferably, R′ further comprises RH, RH is a heavy rare earth element, the content of the heavy rare earth element is preferably 1-2.5%, the percentage refers to the mass percentage relative to the total mass of the raw material composition of neodymium-iron-boron magnet material.

In the present disclosure, the raw material composition of neodymium-iron-boron magnet material preferably comprises the following components by mass percentage: 29.5-32% of R′. R′ is a rare earth element and includes Pr and Nd; wherein, Pr≥17.15%; Cu≥0.35%; Ga≤0.42%; 0.25-0.3% of Zr; 0.9-1.2% of B; 64-69.2% of Fe; more preferably, the content of Pr is 17.15-26%; more preferably, the content of Cu is 0.35-1.3%; more preferably, R′ further comprises RH, RH is a heavy rare earth element, the content of the heavy rare earth element is preferably 1-2.5%, the percentage refers to the mass percentage relative to the total mass of the raw material composition of neodymium-iron-boron magnet material.

In the present disclosure, the raw material composition of neodymium-iron-boron magnet material preferably comprises the following components by mass percentage: 29.5-32% of R′, R′ is a rare earth element and includes Pr and Nd; wherein, Pr≥17.15%; Cu≥0.35%; Al≤0.5%; Ga≤0.42%; 0.25-0.3% of Zr; 0.9-1.2% of B; 64-69.2% of Fe; more preferably, the content of Pr is 17.15-26%; more preferably, the content of Cu is preferably 0.35-1.2%, more preferably, R′ further comprises RH, RH is a heavy rare earth element, the content of the heavy rare earth element is preferably 1-2.5%; the kind of RH preferably comprises Dy and/or Tb, wherein, the content of Tb is preferably 0.5-2%, the content of Dy is preferably 1% or less; the percentage refers to the mass percentage relative to the total mass of the raw material composition of neodymium-iron-boron magnet material.

In the present disclosure, the percentage refers to the mass percentage of each component relative to the total mass of the raw material composition of neodymium-iron-boron magnet material.

The present disclosure further provides a preparation method for neodymium-iron-boron magnet material, which employs the raw material composition of neodymium-iron-boron magnet material mentioned above to prepare.

In the present disclosure, the preparation method preferably comprises the following steps: the molten liquid of the raw material composition of neodymium-iron-boron magnet material is subjected to melting and casting, hydrogen decrepitation, forming, sintering and ageing treatment.

In the present disclosure, the molten liquid of the raw material composition of neodymium-iron-boron magnet material can be prepared by the conventional method in the field, for example: melting in a high frequency vacuum induction melting furnace. The vacuum degree of the melting furnace can be 5×10⁻² Pa. The temperature of the melting can be 1500° C. or less.

In the present disclosure, the operations and conditions of casting can be conventional in the field, for example, in Ar atmosphere (for example in Ar atmosphere of 5.5×10⁴ Pa), cooling at 10²° C./sec-10⁴° C./sec.

In the present disclosure, the operations and conditions of hydrogen decrepitation can be conventional in the field. For example, being subject to hydrogen absorption, dehydrogenation and cooling treatment.

Wherein, the hydrogen absorption can be carried out at the pressure of 0.15 Mpa.

Wherein, the dehydrogenation can be carried out under the condition of heating while evacuating.

In the present disclosure, the conventional pulverization in the field can be carried out after hydrogen decrepitation. The pulverization process can be conventional in the field, for example jet mill pulverization. The jet mill pulverization is preferably carried out in nitrogen atmosphere with 150 ppm or less of oxidizing gas. The oxidizing gas refers to the content of oxygen or moisture. The pressure of the pulverization chamber of jet mill pulverization is preferably 0.38 Mpa; the time of the jet mill pulverization is preferably 3 h.

Wherein, after the pulverization, lubricants can be added to the powder by the conventional method in the field, for example zinc stearate. The amount of lubricant added can be 0.10-0.15% of the weight of the mixed powder, for example 0.12%.

In the present disclosure, the operations and conditions of the forming can be conventional in the field, for example magnetic field forming method or hot press and hot deformation method.

In the present disclosure, the operations and conditions of the sintering can be conventional in the field. For example, preheating, sintering and cooling in vacuum (for example in vacuum of 5×10³ Pa).

Wherein, the temperature of the preheating is usually 300-600° C. The time of the preheating is usually 1-2 h. The preheating is preferably carried out at 300° C. and 600° C. for 1 h respectively.

Wherein, the temperature of the sintering is preferably 1030-1080° C., for example 1040° C.

Wherein, the time of the sintering is conventional in the field, for example 2h.

Wherein, before the cooling. Ar gas can be introduced to make the pressure reach 0.1 Mpa.

In the present disclosure, after the sintering and before the ageing treatment, a grain boundary diffusion treatment is further carried out preferably.

Wherein, the operations and conditions of the grain boundary diffusion can be conventional in the field. For example, the surface of the neodymium-iron-boron magnet material are attached with Tb-containing substance and/or Dy-containing substance by evaporating, coating or sputtering, and subjected to diffusion heat treatment.

The Tb-containing substance can be a Tb metal, a Tb-containing compound, for example a Tb-containing fluoride or alloy.

The Dy-containing substance can be a Dy metal, a Dy-containing compound, for example a Dy-containing fluoride or alloy.

The temperature of the diffusion heat treatment may be 800-900° C., for example 850° C.

The time of the diffusion heat treatment can be 12-48 h, for example 24h.

In the present disclosure, in the ageing treatment, the temperature of secondary ageing treatment is preferably 520-650° C., for example 550° C.

In the present disclosure, in the secondary ageing treatment, heating rate to 550-650° C. is preferably 3-5° C./min. The starting point of heating can be room temperature.

In the present disclosure, the room temperature is 25° C.±5° C.

The present disclosure further provides a neodymium-iron-boron magnet material, which is prepared by the preparation method mentioned above.

The present disclosure provides a neodymium-iron-boron magnet material, the neodymium-iron-boron magnet material comprises the following components by mass percentage:
29.4-32.6% of R′, R′ includes Pr and Nd; wherein, Pr≥17.14%;
Cu≥0.34%;
0.9-1.2% of B;
64-69.2% of Fe;
the percentage refers to the mass percentage relative to the total mass of the neodymium-iron-boron magnet material.

In the present disclosure, the content of Pr is preferably 17.14-26.1%, for example 17.149%, 17.15%, 17.154%, 18.15%, 18.152%, 18.154%, 18.155%, 19.15%, 19.152%, 19.154%, 19.155%, 19.159%, 20.13%, 20.155%, 20.16%, 21.157%, 22.15%, 22.151%, 22.152%, 22.1555%, 23.15%, 24.151%, 24.152%, 24.155%, 24.157%, 24.158%, 25.15%, 25.152%, 25.153%, 25.156% or 26.01%, the percentage refers to the mass percentage relative to the total mass of the neodymium-iron-boron magnet material.

In the present disclosure, the content of Nd is preferably 15% or less, more preferably 4-13%, for example 4.02%, 5.847%, 5.84%, 5.849%, 5.85%, 5.851%, 5.852%, 5.853%, 5.854%, 6.851%, 6.852%, 6.853%, 7.85%, 8.846%, 8.847%, 8.85%, 8.851%, 8.852%, 8.853%, 9.85%, 9.851%, 10.844%, 10.846%, 10.849%, 11.349%, 11.384%, 12.341%, 12.345%, 12.348%, 12.35%, 12.351%, 12.364%, 12.791%, 12.802% or 12.849%, the percentage refers to the mass percentage relative to the total mass of the neodymium-iron-boron magnet material.

In the present disclosure, the ratio of the mass of Nd to the total mass of R′ is preferably less than 0.5, more preferably 0.1-0.45, for example 0.1, 0.12, 0.13, 0.18, 0.2, 0.21, 0.23, 0.24, 0.25, 0.26, 0.27, 0.3, 0.31, 0.37, 0.38, 0.4, 0.41 or 0.42.

In the present disclosure, the content of R′ is preferably 29.49-32.53%, for example 29.495%, 29.501%, 30.003%, 30.004%, 30.03%, 30.441%, 30.517%, 30.518%, 30.957%, 30.98%, 31%, 31.006%, 31.0065%, 31.009%, 31.011%, 31.012%, 31.013%, 31.498%, 31.504%, 31.539%, 31.946%, 31.972%, 31.977%, 31.995%, 31.999%, 32%, 32.001%, 32.013%, 32.015%, 32.021%, 32.022%, 32.023%, 32.024%, 32.025%, 32.026%, 32.027%, 32.04%, 32.043%, 32.437% or 32.521%, the percentage refers to the mass percentage relative to the total mass of the neodymium-iron-boron magnet material.

In the present disclosure, preferably, R′ further comprises other rare earth elements besides Pr and Nd, for example Y.

In the present disclosure, preferably, R′ further comprises RH, RH is a heavy rare earth element, the kind of RH preferably comprises one or more of Dy, Tb and Ho, more preferably Dy and/or Tb.

Wherein, the mass ratio of RH and R′ is preferably less than 0.253, preferably 0-0.07, for example 1.01/32.015, 1.02/30.517, 1.02/32.021, 1.02/32.023, 1.02/32.024, 1.02/32.024, 1.02/32.025, 1.02/32.025, 1.02/32.026, 1.03/32.04, 1.04/32.043, 1.432/32.437, 1.46/30.441, 1.47/31.972, 1.48/31.977, 1.5/32, 1.52/32.521, 1.98/30.98, 1.99/31.995, 1/31.999, 1/32, 2.01/31.011, 2.01/31.013, 2.01/32.013, 2.02/32.022, 2.02/32.027, 2/31 or 2/31.012.

Wherein, the content of RH is preferably 1-2.5%, for example 1%, 1.01%, 1.02%, 1.03%, 1.04%, 1.432%, 1.46%, 1.47%, 1.48%, 1.5%, 1.52%, 1.98%, 1.99%, 2%, 2.01% or 2.02%, the percentage refers to the mass percentage relative to the total mass of the neodymium-iron-boron magnet material.

When RH comprises Tb, the content of Tb is preferably 0.5-2 wt. %, for example 0.7%, 0.72%, 0.82%, 0.9%, 0.91%, 1%, 1.02%, 1.47%, 1.48%, 1.5%, 1.81%, 1.88%, 1.89%, 1.9%, 1.91% or 2.01%, the percentage refers to the mass percentage relative to the total mass of the neodymium-iron-boron magnet material.

When RH comprises Dy, the content of Dy is preferably 0.5 wt. % or less, for example 0.1%, 0.2%, 0.21%, 0.3%, 0.31% or 0.312%, the percentage refers to the mass percentage relative to the total mass of the neodymium-iron-boron magnet material.

When RH comprises Ho, the content of Ho is a conventional content in the field, usually 0.8-2%, for example 0.98%, 0.99% or 1%, the percentage refers to the mass percentage relative to the total mass of the neodymium-iron-boron magnet material.

In the present disclosure, the content of Cu is preferably 0.34-1.3%, for example 0.341%, 0.41%, 0.452%, 0.47%, 0.502%, 0.51%, 0.52%, 0.598%, 0.62%, 0.648%, 0.649%, 0.701%, 0.702%, 0.71%, 0.78%, 0.79%, 0.795%, 0.806%, 0.81%, 0.852%, 0.89%, 0.901%, 0.903%, 0.91%, 0.92%, 0.948%, 1.021%, 1.05%, 1.08%, 1.101%, 1.103%, 1.12%, 1.18%, 1.19%, 1.202% or 1.21%, the percentage refers to the mass percentage relative to the total mass of the neodymium-iron-boron magnet material.

In the present disclosure, the content of B is preferably 0.95-1.2%, for example 0.983%, 0.984%, 0.985%, 0.988%, 0.989%, 1.02% or 1.19%, the percentage refers to the mass percentage relative to the total mass of the neodymium-iron-boron magnet material.

In the present disclosure, the content of Fe is preferably 64.8-69.2%, for example 64.965% 0.65.031%, 65.095%, 65.155%, 65.204%, 65.36%, 65.4%, 65.458%, 65.525%, 65.626%, 65.63%, 65.686%, 65.817%, 65.8395%, 65.869%, 65.909%, 65.963%, 65.994%, 65.995%, 66.039%, 66.04%, 66.099%, 66.157%, 66.218%, 66.267%, 66.364%, 66.377%, 66.427%, 66.437%, 66.52%, 66.605%, 66.671%, 66.8075%, 66.81%, 66.87%, 67.095%, 67.12%, 67.137%, 67.457%, 67.578%, 67.996%, 68.302%, 68.556% or 69.181%, the percentage refers to the mass percentage relative to the total mass of the neodymium-iron-boron magnet material.

In the present disclosure, preferably, the neodymium-iron-boron magnet material further comprises Al.

In the present disclosure, the content of Al is preferably 0.5% or less, more preferably 0.03-0.5 wt. %, for example 0.01%, 0.02%, 0.03%, 0.1%, 0.102%, 0.12%, 0.2%, 0.21%, 0.24%, 0.25%, 0.29%, 0.3%, 0.31%, 0.38%, 0.4%, 0.42%, 0.45%, 0.46% or 0.48%, the percentage refers to the mass percentage relative to the total mass of the neodymium-iron-boron magnet material.

In the present disclosure, preferably, the neodymium-iron-boron magnet material further comprises Zr.

In the present disclosure, the content of Zr is preferably 0.05-0.31 wt. %, for example 0.1%, 0.21%, 0.22%, 0.25%, 0.251%, 0.252%, 0.261%, 0.272%, 0.28%, 0.281%, 0.282%, 0.291% 0.3% or 0.301%, more preferably 0.25-0.31, the percentage refers to the mass percentage of each component relative to the total mass of the neodymium-iron-boron magnet material.

In the present disclosure, preferably, the neodymium-iron-boron magnet material further comprises Ga.

Wherein, the content of Ga is preferably 0.51% or less, more preferably 0.1-0.51%, for example 0.1%, 0.101%, 0.102%, 0.11%, 0.12%, 0.152%, 0.18%, 0.2%, 0.202%, 0.24%, 0.25%, 0.251%, 0.302%, 0.401% or 0.501%, the percentage refers to the mass percentage of each component relative to the total mass of the neodymium-iron-boron magnet material.

In the present disclosure, preferably, the neodymium-iron-boron magnet material further comprises Co.

Wherein, the content of Co is preferably 0.2-1.5%, for example 0.2% or 1%, the percentage refers to the mass percentage of each component relative to the total mass of the neodymium-iron-boron magnet material.

In the present disclosure, preferably, the neodymium-iron-boron magnet material further comprises O.

Wherein, the content of O is preferably 0.13% or less, the percentage refers to the mass percentage of each component relative to the total mass of the neodymium-iron-boron magnet material.

In the present disclosure, the neodymium-iron-boron magnet material can further comprise other conventional elements in the field, for example one or more of Zn, Ag, In, Sn, V, Cr, Nb, Ti, Mo. Ta, Hf and W.

Wherein, the content of Zn can be a conventional content in the field, preferably 0.02-0.08%, for example 0.03%, 0.04% or 0.07%, the percentage refers to the mass percentage of each component relative to the total mass of the neodymium-iron-boron magnet material.

Wherein, the content of Mo can be a conventional content in the field, preferably 0.01-0.08%, for example 0.03%, 0.06% or 0.07%, the percentage refers to the mass percentage of each component relative to the total mass of the neodymium-iron-boron magnet material.

In the present disclosure, the neodymium-iron-boron magnet material preferably comprises the following components by mass percentage: 29.4-32.6% of R′, R′ is a rare earth element and includes Pr and Nd; wherein, Pr≥17.14%; Cu≥0.34%; Al≤0.5%; 0.9-1.2% of B; 64-69.2% of Fe; more preferably, the content of Pr is 17.14-26.1%; more preferably, the content of Cu is preferably 0.35-1.2%; more preferably, R′ further comprises RH, RH is a heavy rare earth element, the content of the heavy rare earth element is preferably 1-2.5%, the percentage refers to the mass percentage relative to the total mass of the neodymium-iron-boron magnet material.

In the present disclosure, the neodymium-iron-boron magnet material preferably comprises the following components by mass percentage: 29.4-32.6% of R′, R′ is a rare earth element and includes Pr and Nd; wherein, Pr 217.15%; Cu≥0.34%; 0.25-0.3% of Zr; 0.9-1.2% of B; 64-69.2% of Fe; more preferably, the content of Pr is 17.14-26.1%; more preferably, the content of Cu is preferably 0.35-1.2%; more preferably, R′ further comprises RH, RH is a heavy rare earth element, the content of the heavy rare earth element is preferably 1-2.5%, the percentage refers to the mass percentage relative to the total mass of the neodymium-iron-boron magnet material.

In the present disclosure, the neodymium-iron-boron magnet material preferably comprises the following components by mass percentage: 29.4-32.6% of R′, R′ is a rare earth element and includes Pr and Nd; wherein, Pr≥17.14%; Cu≥0.34%; Al≤4.5%; 0.25-0.3% of Zr; 0.9-1.2% of B; 64-69.2% of Fe; more preferably, the content of Pr is 17.14-26.1%; more preferably, the content of Cu is preferably 0.35-1.2%; more preferably. R′ further comprises RH, RH is a heavy rare earth element, the content of the heavy rare earth element is preferably 1-2.5%; the kind of RH preferably comprises Dy and/or Tb, wherein, the content of Tb is preferably 0.5-2%, the content of Dy is preferably 10% or less; the percentage refers to the mass percentage relative to the total mass of the neodymium-iron-boron magnet material.

In the present disclosure, the neodymium-iron-boron magnet material preferably comprises the following components by mass percentage: 29.4-32.6% of R′, R′ is a rare earth element and includes Pr and Nd; wherein, Pr≥17.14%; Cu≥0.34%; Ga≤0.42%; 0.9-1.2% of B; 64-69.2% of Fe; more preferably, the content of Pr is 17.14-26.1%; more preferably, the content of Cu is preferably 0.35-1.3%; more preferably, R′ further comprises RH, RH is a heavy rare earth element, the content of the heavy rare earth element is preferably 1-2.5%, the percentage refers to the mass percentage relative to the total mass of the neodymium-iron-boron magnet material.

In the present disclosure, the neodymium-iron-boron magnet material preferably comprises the following components by mass percentage: 29.4-32.6% of R′, R′ is a rare earth element and includes Pr and Nd; wherein, Pr≥17.14%; Cu≥0.34%; Al≤4.5%; Ga≤0.42%; 0.9-1.2% of B; 64-69.2% of Fe; more preferably, the content of Pr is 17.14-26.1%; more preferably, the content of Cu is preferably 0.35-1.3%; more preferably, R′ further comprises RH, RH is a heavy rare earth element, the content of the heavy rare earth element is preferably 1-2.5%, the percentage refers to the mass percentage relative to the total mass of the neodymium-iron-boron magnet material.

In the present disclosure, the neodymium-iron-boron magnet material comprises the following components by mass percentage: 29.4-32.6% of R′, R′ is a rare earth element and includes Pr and Nd; wherein, Pr 217.14%; Cu≥0.34%; Ga≤0.42%; 0.25-0.3% of Zr; 0.9-1.2% of B; 64-69.2% of Fe; more preferably, the content of Pr is 17.14-26.1%; more preferably, the content of Cu is preferably 0.35-1.3%, more preferably, R′ further comprises RH. RH is a heavy rare earth element, the content of the heavy rare earth element is preferably 1-2.5%, the percentage refers to the mass percentage relative to the total mass of the neodymium-iron-boron magnet material.

In the present disclosure, the raw material composition of neodymium-iron-boron magnet material comprises the following components by mass percentage: 29.4-32.6% of R′, R′ is a rare earth element and includes Pr and Nd; wherein, Pr≥17.14%; Cu≥0.34%; Al≤0.5%; Ga≤0.42%; 0.25-0.3% of Zr; 0.9-1.2% of B; 64-69.2% of Fe; more preferably, the content of Pr is 17.14-26.1%; more preferably, the content of Cu is preferably 0.35-1.3%, more preferably, R′ further comprises RH, RH is a heavy rare earth element, the content of the heavy rare earth element is preferably 1-2.5%; the kind of RH preferably comprises Dy and/or Tb, wherein, the content of Tb is preferably 0.5-2%, the content of Dy is preferably 1% or less; the percentage refers to the mass percentage relative to the total mass of the neodymium-iron-boron magnet material.

In the present disclosure, the percentage refers to the mass percentage of each component relative to the total mass of the neodymium-iron-boron magnet material.

The present disclosure further provides a neodymium-iron-boron magnet material, in the intergranular triangle region of the neodymium-iron-boron magnet material, the ratio of the total mass of Pr and Cu to the total mass of each element in the intergranular triangle region is Q1; at the grain boundary of the neodymium-iron-boron magnet material, the ratio of the total mass of Pr and Cu to the total mass of each element at the grain boundary is Q2; wherein, Q1<Q2, and Q2≥0.1;

Preferably, the components of the neodymium-iron-boron magnet material refer to those of the neodymium-iron-boron magnet material mentioned above.

In the present disclosure, the grain boundary refers to the boundary between two grains, and the intergranular triangle is the gap formed by three and more grains.

The present disclosure further provides a use of the neodymium-iron-boron magnet material as an electronic component in a motor.

In the present disclosure, the motor is preferably a new energy vehicle drive motor, an air-conditioning compressor or an industrial servo motor, a wind turbine, an energy-saving elevator or a loudspeaker assembly.

Based on the common sense in the field, the preferred conditions of the preparation methods can be combined arbitrarily to obtain preferred examples of the present disclosure.

The reagents and raw materials used in the invention are commercially available.

The positive progress of the present invention is that the neodymium-iron-boron magnet material of the present invention simultaneously increases the content of praseodymium and copper, so that the grain boundary phase is clearer, and the obtained neodymium-iron-boron magnet material has higher remanence and coercive force.

### BRIEF DESCRIPTION OF THE DRAWINGS

FIG. 1 is the distribution diagram of Pr, Nd, Cu, Ti, Co and O elements formed by the FE-EPMA face scan of the neodymium-iron-boron magnet material prepared in Example 10.

FIG. 2 is the distribution diagram of elements at the grain boundary of the neodymium-iron-boron magnet material in Example 10, and symbol 1 in FIG. 2 is the point taken in quantitative analysis at the grain boundary.

FIG. 3 is the distribution diagram of elements in the intergranular triangle of the neodymium-iron-boron magnet material in Example 10, and symbol 1 in FIG. 3 is the point taken in quantitative analysis at the grain boundary.

### DETAILED DESCRIPTION OF THE PREFERRED EMBODIMENT

The following examples further illustrate the present disclosure, but the present disclosure is not limited thereto. Experiment methods in which specific conditions are not indicated in the following embodiments are selected according to conventional methods and conditions, or according to the product specification. In the table below, wt. % refers to the mass percentage of the component in the raw material composition of the R-T-B permanent magnet material, and “/” indicates that the element has not been added. “Br” is the residual magnetic flux density and “Hcj” is the intrinsic coercivity.

The formulations for the raw material compositions of the neodymium-iron-boron magnet material in each Example and Comparative Example are shown in Table 1 below.

TABLE 1
The formulations for the raw material compositions of the neodymium-iron-
boron magnet material in each Example and Comparative Example (wt. %)

| No. | Nd | Pr | Dy | Tb | Ho | Cu | Al | Ga | Zr | Co | Zn | Mo | B | Fe |
|---|---|---|---|---|---|---|---|---|---|---|---|---|---|---|
| 1 | 12.35 | 17.15 | / | / | / | 0.35 | / | / | / | / | / | / | 0.985 | 69.165 |
| 2 | 12.85 | 17.15 | / | / | / | 0.45 | / | / | / | / | / | / | 0.985 | 68.565 |
| 3 | 12.35 | 18.15 | / | / | / | 0.5 | / | / | / | / | / | / | 0.985 | 68.015 |
| 4 | 12.85 | 18.15 | / | / | / | 0.6 | / | / | / | / | / | / | 0.985 | 67.415 |
| 5 | 12.35 | 19.15 | / | / | / | 0.65 | / | / | / | / | / | / | 0.985 | 66.865 |
| 6 | 12.85 | 19.15 | / | / | / | 0.7 | / | / | / | / | / | / | 0.985 | 66.315 |
| 7 | 11.35 | 20.15 | / | / | / | 0.8 | / | / | / | / | / | / | 0.985 | 66.715 |
| 8 | 11.35 | 20.15 | / | / | / | 0.9 | / | / | / | / | / | / | 0.985 | 66.615 |
| 9 | 10.85 | 21.15 | / | / | / | 1 | / | / | / | / | / | / | 0.985 | 66.015 |
| 10 | 4 | 26 | / | / | / | 1.1 | / | / | 0.1 | 0.2 | / | / | 0.985 | 67.615 |
| 11 | 8.85 | 22.15 | / | / | / | 1.2 | / | / | / | / | / | / | 0.985 | 66.815 |
| 12 | 5.85 | 25.15 | 0.3 | 0.7 | / | 0.5 | 0.03 | / | / | / | / | / | 0.985 | 66.485 |
| 13 | 5.85 | 25.15 | / | 1 | / | 0.7 | 0.1 | / | / | / | / | / | 0.985 | 66.215 |
| 14 | 5.85 | 24.15 | 0.2 | 1.8 | / | 0.9 | 0.2 | / | / | / | / | / | 0.985 | 65.915 |
| 15 | 5.85 | 24.15 | / | 2 | / | 1.1 | 0.25 | / | / | / | / | / | 0.985 | 65.665 |
| 16 | 8.85 | 22.15 | 0.2 | 0.8 | / | 1.2 | / | 0.1 | / | / | / | / | 0.985 | 65.715 |
| 17 | 8.85 | 22.15 | 0 | 1 | / | 0.85 | / | 0.2 | / | / | / | / | 0.985 | 65.965 |
| 18 | 7.85 | 23.15 | 0.1 | 0.9 | / | 0.65 | / | / | 0.1 | / | / | / | 0.985 | 66.265 |
| 19 | 7.85 | 23.15 | 0.1 | 0.9 | / | 0.95 | / | / | 0.25 | / | / | / | 0.985 | 65.815 |
| 20 | 12.35 | 18.15 | / | 1.5 | / | 1.05 | / | / | / | 1 | | | 0.985 | 64.965 |
| 21 | 10.85 | 19.15 | 0.1 | 1.9 | / | 0.8 | 0.1 | 0.1 | / | / | / | / | 0.985 | 66.015 |
| 22 | 10.85 | 19.15 | 0.1 | 1.9 | / | 0.9 | 0.3 | 0.2 | / | / | / | / | 0.985 | 65.615 |
| 23 | 12.35 | 18.15 | / | 1.5 | / | 0.5 | / | 0.25 | 0.22 | / | / | / | 0.985 | 66.045 |
| 24 | 12.35 | 18.15 | / | 1.5 | / | 0.6 | / | 0.1 | 0.28 | / | / | / | 0.985 | 66.035 |
| 25 | 9.85 | 19.15 | 0.1 | 1.9 | / | 1.2 | 0.2 | / | 0.25 | / | / | / | 0.985 | 66.365 |
| 26 | 9.85 | 19.15 | 0.1 | 1.9 | / | 0.8 | 0.4 | / | 0.3 | / | / | / | 0.985 | 66.515 |
| 27 | 8.85 | 22.15 | 0.1 | 0.9 | / | 0.9 | 0.3 | / | 0.26 | / | / | / | 1 | 65.54 |
| 28 | 5.85 | 25.15 | 0.2 | 0.8 | / | 1.2 | 0.46 | / | 0.29 | / | | | 0.985 | 65.065 |
| 29 | 5.85 | 25.15 | 0.3 | 0.7 | / | 1.1 | 0.48 | / | 0.3 | / | | | 0.985 | 65.135 |
| 30 | 9.85 | 19.15 | 0.1 | 1.9 | / | 0.6 | 0.2 | 0.15 | 0.2 | / | | | 0.985 | 66.865 |
| 31 | 8.85 | 22.15 | 0.3 | 0.7 | / | 0.8 | 0.3 | 0.18 | 0.25 | / | | | 0.985 | 65.485 |
| 32 | 6.85 | 24.15 | / | / | / | 0.8 | 0.4 | 0.2 | 0.27 | / | | | 1.1 | 66.23 |
| 33 | 6.85 | 24.15 | / | / | / | 0.9 | 0.45 | 0.2 | 0.28 | / | | | 1.2 | 65.93 |
| 34 | 9.85 | 19.15 | / | 2 | / | 0.4 | 0.1 | 0.1 | 0.25 | | | | 0.985 | 67.165 |
| 35 | 6.85 | 24.15 | / | 1 | / | 0.5 | 0.25 | 0.1 | 0.3 | | | | 0.985 | 65.865 |
| 36 | 12.35 | 17.15 | | | | 0.7 | 0.02 | 0.25 | 0.25 | | | | 0.985 | 68.295 |
| 37 | 12.35 | 17.15 | | 1 | | 0.8 | 0.02 | 0.3 | 0.25 | | | | 0.985 | 67.145 |
| 38 | 8.85 | 22.15 | 0.3 | 0.7 | | 0.9 | 0.03 | 0.4 | 0.28 | | | | 0.985 | 65.405 |
| 39 | 8.85 | 22.15 | 0.3 | 0.7 | | 1.1 | 0.03 | 0.5 | 0.3 | | | | 0.985 | 65.085 |
| 40 | 8.85 | 20.15 | 0.3 | 0.7 | 1.0 | 0.8 | 0.3 | 0 | 0.25 | / | 0.04 | 0.08 | 0.985 | 66.545 |
| 41 | 8.85 | 20.15 | 0.3 | 0.7 | 1.0 | 0.9 | 0.3 | 0 | 0.25 | / | 0.08 | 0.04 | 0.985 | 66.445 |
| 42 | 6.85 | 24.15 | / | / | 1.0 | 0.9 | 0.4 | 0 | 0.25 | / | 0.05 | 0.05 | 0.985 | 65.365 |
| 45 | 5.85 | 25.15 | / | 1 | / | 0.2 | 0.1 | / | / | / | / | / | 0.985 | 66.715 |
| 46 | 5.85 | 25.15 | / | 1 | / | 0.1 | 0.1 | / | / | / | / | / | 0.985 | 66.815 |
| 47 | 14.85 | 15.15 | | | / | 0.9 | 0.2 | / | / | / | / | / | 0.985 | 67.915 |
| 48 | 21.15 | 8.85 | | | / | 0.9 | 0.2 | / | / | / | / | / | 0.985 | 67.915 |

### Example 1

The neodymium-iron-boron magnet material is prepared as follows:

(1) Melting and casting process: according to the formulation shown in Table 1, the prepared raw material was put into a crucible made of alumina and vacuum melted in a high frequency vacuum induction melting furnace and in a vacuum of 5×10⁻² Pa at a temperature of 1500° C. or less. After the vacuum melting, Ar gas was introduced into the melting furnace to make the pressure of furnace reach 55,000 Pa, casting was carried out, and the quenched alloy was obtained at a cooling rate of 10²° C./sec to 10⁴° C./sec.

(2) Hydrogen decrepitation process: the melting furnace in which the quench alloy was placed was evacuated at room temperature, and then hydrogen of 99.9% purity was introduced into the furnace for hydrogen decrepitation to maintain the hydrogen pressure at 0.15 Mpa; after full hydrogen absorption, vacuuming was conducted while heating up to fully dehydrogenate; then cooling was carried out and the powder after hydrogen decrepitation was taken out.

(3) Micro pulverization process: the powder after hydrogen decrepitation was pulverized by jet mill for 3 hours under a nitrogen atmosphere with an oxidizing gas content of 150 ppm or less and under a pressure of 0.38 MPa in the pulverization chamber to obtain a fine powder. The oxidizing gas referred to oxygen or moisture.

(4) Zinc stearate was added to the powder from jet mill pulverization, and the addition amount of zinc stearate was 0.12% of the weight of the mixed powder, and then mixed thoroughly with a V-mixer.

(5) Magnetic field forming process: the above-mentioned zinc stearate added powder was formed into a first cube with a side length of 25 mm by using a right-angle oriented magnetic field forming machine at an oriented magnetic field of 1.6 T and a forming pressure of 0.35 ton/cm²; and it was demagnetised in a magnetic field of 0.2 T after the first forming. In order to prevent the formed body obtained after the first forming from being exposed to air, it was sealed, and then a secondary forming machine (isostatic forming machine) was used to perform secondary forming at a pressure of 1.3 ton/cm².

(6) Sintering process: each formed body was moved to the sintering furnace for sintering, which was held in vacuum of 5×10⁻³ Pa at 300° C. and 600° C. for 1 hour respectively; then, sintered at 1040° C. for 2 hours; then cooled to room temperature after the pressure reached 0.1 Mpa by introducing Ar gas.

(7) Ageing treatment process: the sintered body was heat treated in high purity Ar gas at 550° C. for 3 hours and then it was cooled to room temperature before being taken out.

The preparation process of Example 2-42 and Comparative Examples 45-48 was the same as that of Example 1.

Example 43 and 44 employed Tb grain boundary diffusion method in the preparation process.

The raw material compositions of No. 12 and 16 in Table 1 were first prepared according to the preparation of the sintered body of Example 1 to obtain a sintered body, followed by grain boundary diffusion, and then ageing treatment was carried out. The ageing treatment process was the same as in Example 1, and the process of grain boundary diffusion was as follows.

The sintered body was processed into a magnet with a diameter of 20 mm and a sheet thickness of less than 7 mm in the direction of the magnetic field orientation, and after surface cleaning, the magnet was coated with a full spray using a raw material prepared with Tb fluoride, respectively, and the coated magnet was dried and the metal with Tb element attached was sputtered on the magnet surface in a high purity Ar atmosphere at the temperature of 850° C. diffusion heat treatment for 24 hours. Cool to room temperature.

### Examples of Effect Implementation

The magnetic properties and compositions of the neodymium-iron-boron magnet materials produced in each example and comparative example were measured and the crystalline phase structure of the magnets is observed by FE-EPMA.

(1) Magnetic properties evaluation: The magnet materials were tested for magnetic properties by using the NIM-10000H BH bulk rare earth permanent magnet non-destructive measurement system from the China Metrology Institute. The results of the magnetic properties testing were shown in Table 2 below.

TABLE 2

| | | | 80° C. Hcj | 150° C. Hcj | 180° C. Hcj |
|---|---|---|---|---|---|
| | | | Absolute | Absolute | Absolute |
| | | | value of | value of | value of |
| | | | temperature | temperature | temperature |
| No. | Br(kGs) | Hcj(kOe) | coefficient | coefficient | coefficient |
| 1 | 14.35 | 17.01 | 0.689 | / | / |
| 2 | 14.16 | 17.62 | 0.684 | / | / |
| 3 | 13.98 | 18.03 | 0.679 | / | / |
| 4 | 14.01 | 18.21 | 0.674 | / | / |
| 5 | 13.84 | 18.56 | 0.672 | / | / |
| 6 | 13.65 | 18.88 | 0.668 | / | / |
| 7 | 13.7 | 19.15 | 0.663 | / | / |
| 8 | 13.62 | 19.39 | 0.663 | / | / |
| 9 | 13.5 | 20.11 | 0.652 | / | / |
| 10 | 13.49 | 20.64 | 0.648 | / | / |
| 11 | 13.7 | 22 | 0.621 | / | / |
| 12 | 13.30 | 23.6 | 0.601 | / | / |
| 13 | 13.19 | 25.24 | / | 0.515 | / |
| 14 | 13.06 | 28.02 | / | 0.485 | / |
| 15 | 13.00 | 28.98 | / | 0.479 | / |
| 16 | 13.59 | 24.48 | / | 0.523 | / |
| 17 | 13.25 | 24.68 | / | 0.520 | / |
| 18 | 13.29 | 22.73 | 0.619 | / | / |
| 19 | 13.15 | 24.03 | / | 0.520 | / |
| 20 | 13.02 | 25.23 | | 0.515 | |
| 21 | 13.27 | 26.81 | / | 0.512 | / |
| 22 | 13.07 | 28.71 | / | 0.491 | / |
| 23 | 13.34 | 25.66 | / | 0.519 | / |
| 24 | 13.29 | 25.08 | / | 0.522 | / |
| 25 | 13.39 | 27.24 | | 0.493 | / |
| 26 | 12.91 | 27.09 | | 0.503 | |
| 27 | 13.29 | 24.69 | / | 0.531 | / |
| 28 | 13.01 | 26.97 | / | 0.508 | / |
| 29 | 12.66 | 26.84 | | 0.511 | |
| 30 | 13.15 | 26.87 | / | 0.504 | / |
| 31 | 13.14 | 26.05 | / | 0.510 | / |
| 32 | 13.10 | 26.68 | / | 0.509 | / |
| 33 | 13.59 | 23.93 | 0.591 | / | / |
| 34 | 13.42 | 24.47 | / | 0.524 | / |
| 35 | 13.18 | 23.73 | 0.593 | / | / |
| 36 | 14.33 | 18.76 | 0.675 | / | / |
| 37 | 13.74 | 23.39 | 0.599 | / | / |
| 38 | 13.19 | 26.04 | / | 0.510 | / |
| 39 | 12.95 | 27.52 | / | 0.488 | / |
| 40 | 12.75 | 24.19 | / | 0.521 | / |
| 41 | 12.79 | 24.23 | / | 0.519 | / |
| 42 | 12.63 | 23.72 | 0.594 | / | / |
| 43 | 13.02 | 33.2 | / | / | 0.428 |
| 44 | 13.37 | 34.8 | / | / | 0 |
| 45 | 13.27 | 21.75 | 0.629 | / | / |
| 46 | 13.30 | 21.53 | 0.632 | / | / |
| 47 | 13.8 | 16.8 | 0.742 | / | / |
| 48 | 14.0 | 14.9 | 0.782 | / | / |

(2) Component determination: each component was determined by using a high frequency inductively coupled plasma emission spectrometer (ICN-OES). The component determination results were shown in Table 3 below.

TABLE 3

| No. | Nd | Pr | Dy | Tb | Ho | Cu | Al | Ga | Zr | Co | Zn | Mo | B | Fe |
|---|---|---|---|---|---|---|---|---|---|---|---|---|---|---|
| 1 | 12.341 | 17.154 | / | / | / | 0.341 | / | / | / | / | / | / | 0.983 | 69.181 |
| 2 | 12.849 | 17.154 | / | / | / | 0.452 | / | / | / | / | / | / | 0.989 | 68.556 |
| 3 | 12.364 | 18.154 | / | / | / | 0.502 | / | / | / | / | / | / | 0.984 | 67.996 |
| 4 | 12.802 | 18.155 | / | / | / | 0.598 | / | / | / | / | / | / | 0.988 | 67.457 |
| 5 | 12.348 | 19.15 | / | / | / | 0.649 | / | / | / | / | / | / | 0.983 | 66.87 |
| 6 | 12.791 | 19.155 | / | / | / | 0.701 | / | / | / | / | / | / | 0.989 | 66.364 |
| 7 | 11.384 | 20.155 | / | / | / | 0.806 | / | / | / | / | / | / | 0.984 | 66.671 |
| 8 | 11.349 | 20.155 | / | / | / | 0.903 | / | / | / | / | / | / | 0.988 | 66.605 |
| 9 | 10.844 | 21.157 | / | / | / | 1.021 | / | / | / | / | / | / | 0.983 | 65.995 |
| 10 | 4.02 | 26.01 | / | / | / | 1.103 | / | / | 0.1 | 0.2 | / | / | 0.989 | 67.578 |
| 11 | 8.851 | 22.1555 | / | / | / | 1.202 | / | / | / | / | / | / | 0.984 | 66.8075 |
| 12 | 5.854 | 25.156 | 0.31 | 0.72 | / | 0.52 | 0.02 | / | / | / | / | / | 0.983 | 66.437 |
| 13 | 5.848 | 25.156 | / | 1.02 | / | 0.71 | 0.12 | / | / | / | / | / | 0.989 | 66.157 |
| 14 | 5.849 | 24.158 | 0.21 | 1.81 | / | 0.91 | 0.21 | / | / | / | / | / | 0.984 | 65.869 |
| 15 | 5.847 | 24.155 | / | 2.02 | / | 1.12 | 0.24 | / | / | / | / | / | 0.988 | 65.63 |
| 16 | 8.846 | 22.155 | 0.2 | 0.82 | / | 1.19 | / | 0.12 | / | / | / | / | 0.983 | 65.686 |
| 17 | 8.85 | 22.15 | 0 | 1 | / | 0.852 | / | 0.2 | / | / | / | / | 0.985 | 65.963 |
| 18 | 7.85 | 23.15 | 0.1 | 0.9 | / | 0.648 | / | / | 0.1 | / | / | / | 0.985 | 66.267 |
| 19 | 7.85 | 23.15 | 0.1 | 0.9 | / | 0.948 | / | / | 0.25 | / | / | / | 0.985 | 65.817 |
| 20 | 12.35 | 18.15 | / | 1.5 | / | 1.05 | / | / | / | 1 | | | 0.985 | 64.965 |
| 21 | 10.849 | 19.154 | 0.1 | 1.91 | / | 0.81 | 0.1 | 0.1 | / | / | / | / | 0.983 | 65.994 |
| 22 | 10.846 | 19.159 | 0.1 | 1.89 | / | 0.89 | 0.3 | 0.2 | / | / | / | / | 0.989 | 65.626 |
| 23 | 12.345 | 18.152 | / | 1.48 | / | 0.47 | / | 0.25 | 0.22 | / | / | / | 0.984 | 66.099 |
| 24 | 12.35 | 18.152 | / | 1.47 | / | 0.62 | / | 0.1 | 0.28 | / | / | / | 0.988 | 66.04 |
| 25 | 9.85 | 19.15 | 0.1 | 1.88 | / | 1.21 | 0.2 | / | 0.25 | / | / | / | 0.983 | 66.377 |
| 26 | 9.85 | 19.15 | 0.1 | 1.9 | / | 0.795 | 0.4 | / | 0.3 | / | / | / | 0.985 | 66.52 |
| 27 | 8.853 | 22.152 | 0.1 | 0.91 | / | 0.91 | 0.3 | / | 0.261 | / | / | / | 0.989 | 65.525 |
| 28 | 5.851 | 25.153 | 0.2 | 0.82 | / | 1.21 | 0.46 | / | 0.291 | / | / | / | 0.984 | 65.031 |
| 29 | 5.85 | 25.15 | 0.3 | 0.7 | / | 1.08 | 0.48 | / | 0.3 | / | / | / | 0.985 | 65.155 |
| 30 | 9.851 | 19.152 | 0.1 | 1.91 | / | 0.62 | 0.21 | 0.152 | 0.21 | / | / | / | 0.985 | 66.81 |
| 31 | 8.853 | 22.152 | 0.3 | 0.72 | / | 0.81 | 0.29 | 0.18 | 0.252 | / | / | / | 0.985 | 65.458 |
| 32 | 6.851 | 24.155 | / | / | / | 0.78 | 0.42 | 0.202 | 0.272 | / | / | / | 1.102 | 66.218 |
| 33 | 6.852 | 24.157 | / | / | / | 0.92 | 0.45 | 0.24 | 0.282 | / | / | / | 1.19 | 65.909 |
| 34 | 9.851 | 19.15 | / | 2.01 | / | 0.41 | 0.102 | 0.101 | 0.251 | / | / | / | 0.988 | 67.137 |
| 35 | 6.852 | 24.151 | / | 1.02 | / | 0.502 | 0.250 | 0.102 | 0.301 | / | / | / | 0.983 | 65.839 |
| 36 | 12.351 | 17.150 | / | / | / | 0.702 | 0.01 | 0.251 | 0.251 | / | / | / | 0.983 | 68.302 |
| 37 | 12.348 | 17.149 | / | 1.02 | / | 0.79 | 0.03 | 0.302 | 0.252 | / | / | / | 0.989 | 67.12 |
| 38 | 8.848 | 22.151 | 0.3 | 0.7 | / | 0.901 | 0.03 | 0.401 | 0.281 | / | / | / | 0.988 | 65.4 |
| 39 | 8.847 | 22.152 | 0.3 | 0.7 | / | 1.101 | 0.02 | 0.501 | 0.301 | / | / | / | 0.983 | 65.095 |
| 40 | 8.851 | 20.13 | 0.3 | 0.17 | 0.99 | 0.81 | 0.31 | 0 | 0.251 | / | 0.04 | 0.07 | 0.983 | 67.095 |
| 41 | 8.852 | 20.16 | 0.3 | 0.72 | 0.98 | 0.91 | 0.31 | 0 | 0.252 | / | 0.07 | 0.03 | 0.989 | 66.427 |
| 42 | 6.853 | 24.152 | / | / | 1.02 | 0.91 | 0.38 | 0 | 0.251 | / | 0.03 | 0.06 | 0.984 | 65.36 |
| 43 | 5.853 | 25.152 | 0.312 | 1.12 | / | 0.51 | 0.03 | / | / | / | / | / | 0.984 | 66.039 |
| 44 | 8.846 | 22.155 | 0.2 | 1.32 | / | 1.18 | / | 0.11 | / | / | / | / | 0.985 | 65.204 |
| 45 | 5.853 | 25.153 | / | 1.02 | / | 0.19 | 0.07 | / | / | / | / | / | 0.988 | 66.726 |
| 46 | 5.852 | 25.151 | / | 1.04 | / | 0.09 | 0.09 | / | / | / | / | / | 0.983 | 66.794 |
| 47 | 14.851 | 15.153 | / | / | / | 0.91 | 0.22 | / | / | / | / | / | 0.983 | 67.883 |
| 48 | 21.152 | 8.852 | / | / | / | 0.93 | 0.21 | / | / | / | / | / | 0.989 | 67.867 |

(3) FE-EPMA inspection: the magnet material of Example 10 was taken to be polished on the vertically oriented surface, and inspected by using the Field Emission Electron Probe Microanalyser (FE-EPMA) (Japan Electronics Company (JEOL), 8530F). The distribution of elements such as Pr, Cu, B, Fe, Co and O in the magnet was first determined by FE-EPMA surface scanning, and then the content of Pr. Cu, O and other elements in the key phase was determined by FE-EPMA single point quantitative analysis, the test conditions were accelerating voltage of 15 kv and probe beam current of 50 nA.

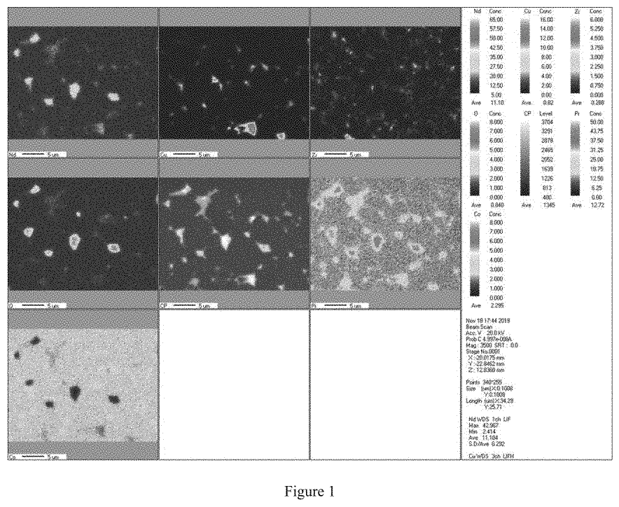

The magnetic steel prepared by the formulation of the present invention was analyzed by means of the Field Emission Electron Probe Microanalyser (FE-EPMA), mainly for the elements Pr, Nd, Cu, Ti, Co and O, as shown in FIG. 1, and quantitative analysis was carried out for the elements at grain boundaries and in the intergranular triangle. Wherein: the grain boundary referred to the boundary between two grains, and the intergranular triangle referred to the gap formed by three and more grains.

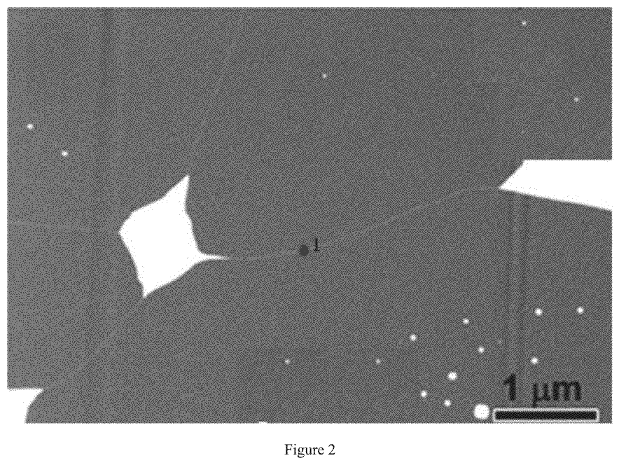

FIG. 2 shows the distribution of elements at the grain boundaries of the neodymium-iron-boron magnet material in Example 10, Pr, Nd elements were mainly distributed in the main phase, part of the rare earth was also present at the grain boundary, element Cu and element Zr were distributed at the grain boundaries, and the point marked 1 in FIG. 2 was taken for quantitative analysis of the elements at the grain boundaries, the results were shown in Table 4 below.

TABLE 4

| Pr | Nd | Cu | Zr | O | Fe |
|---|---|---|---|---|---|
| (wt. %) | (wt. %) | (wt. %) | (wt. %) | (wt. %) | (wt. %) |
| 65.2 | 12.5 | 28.6 | 0.05 | 0.79 | Residual |

From the above data, it can been seen that Pr and Nd were present at the grain boundary in the form of rare earth rich phases and oxides, which were respectively a-Pr and a-Nd, Pr₂O. Nd₂O₃ and NdO, and Cu occupied a certain content of about 28 wt. % at the grain boundary in addition to the main phase, for example 28.6 wt. % in this embodiment. Zr as a high melting point element was diffusely distributed throughout the region, with the effective distribution of Cu, combined with the combined effect of Pr, improved the wettability of the grain boundary, repaired crystal defects and improved the performance of the magnet.

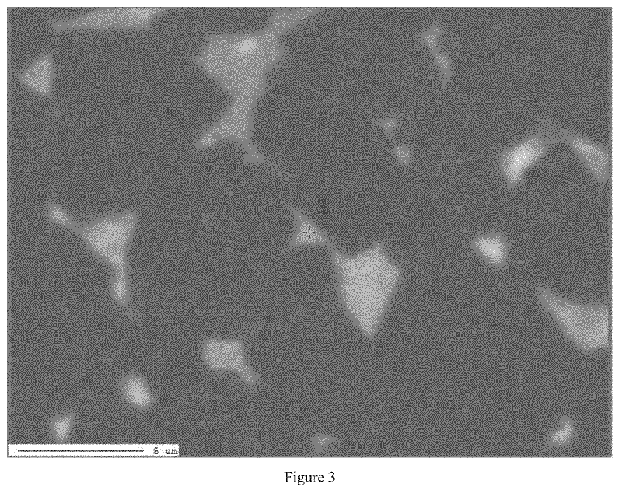

FIG. 3 shows the distribution of elements in the intergranular triangle of the neodymium-iron-boron magnet material in Example 10, the point marked 1 in FIG. 3 was taken for quantitative analysis of the elements in the intergranular triangle, the results were shown in Table 5 below.

TABLE 5

| Pr | Nd | Cu | Zr | O | Fe |
|---|---|---|---|---|---|
| (wt. %) | (wt. %) | (wt. %) | (wt. %) | (wt. %) | (wt. %) |
| 42.2 | 23 | 31 | 0.02 | 1.3 | Residual |

In the intergranular triangle, Pr and Nd elements were distributed therein. In the high-Pr formulation, it is clear that Pr and Nd will be also enriched in the intergranular triangle, where the oxygen content was slightly higher than the grain boundary and the oxides formed increased, and the rare earth oxides were also distributed at the grain boundary after the ageing treatment, which was beneficial to isolate the exchange coupling among the main phases, and the magnetic properties of the magnets were ultimately improved.

1. A raw material composition of neodymium-iron-boron magnet material, wherein, the raw material composition of neodymium-iron-boron magnet material comprises the following components by mass percentage: 29.5-32% of R′, R′ is a rare earth element and includes Pr and Nd; wherein, Pr≥17.15%;
Cu≥0.35%;
0.9-1.2% of B;
64-69.2% of Fe, the percentage refers to the mass percentage relative to the total mass of the raw material composition of neodymium-iron-boron magnet material.

2-10. (canceled)

11. The raw material composition according to claim 1, wherein, the content of Pr is 17.15-26%;
or, the content of Pr is 18.15%, 19.15%, 20.15%, 20.85%, 21.15%, 22.15%, 23.15%, 24.15%, 25.15% or 26%.

12. The raw material composition according to claim 1, wherein, R′ further comprises RH, RH is heavy rare earth element, the kind of RH comprises one or more of Dy, Tb and Ho; the mass ratio of RH and R′ is preferably less than 0.253, the content of RH is 1-2.5%.

13. The raw material composition according to claim 1, wherein, the content of Cu is 0.35-1.3%.

14. The raw material composition according to claim 1, wherein, the raw material composition of neodymium-iron-boron magnet material further comprises Al; the content of Al is 3% or less;
or, the raw material composition of neodymium-iron-boron magnet material further comprises Ga; the content of Ga is 1% or less;
or, the raw material composition of neodymium-iron-boron magnet material further comprises Zr; the content of Zr is 0.3% or less;
or, the raw material composition of neodymium-iron-boron magnet material further comprises Co; the content of Co is 0.2-1.5%;
or, the raw material composition of neodymium-iron-boron magnet material further comprises one or more of Zn, Ag, In, Sn, V, Cr, Mo, Ta, Hf and W.

15. The raw material composition according to claim 1, wherein, the raw material composition comprises the following components by mass percentage: 29.5-32% of R′, R′ is a rare earth element and comprises Pr and Nd; wherein, Pr≥17.15%; Cu≥0.35%; Al≤0.5%; 0.25-0.3% of Zr; 0.9-1.2% of B; 64-69.2% of Fe.

16. The raw material composition according to claim 1, wherein, the raw material composition comprises the following components by mass percentage: 29.5-32% of R′, R′ is a rare earth element and comprises Pr and Nd; wherein, Pr≥17.15%; Cu≥0.35%; Al≤0.5%; Ga≤0.42%; 0.25-0.3% of Zr; 0.9-1.2% of B; 64-69.2% of Fe.

17. A preparation method for neodymium-iron-boron magnet material, wherein, the neodymium-iron-boron magnet material is prepared by using the raw material composition according to claim 1.

18. A preparation method for neodymium-iron-boron magnet material, wherein, the preparation method comprises the following steps: the molten liquid of the raw material composition according to claim 1 is subjected to melting and casting, hydrogen decrepitation, forming, sintering and ageing treatment.

19. A neodymium-iron-boron magnet material, wherein, the neodymium-iron-boron magnet material is prepared by the preparation method according to claim 17.

20. An application of the neodymium-iron-boron magnet material according to claim 19 as an electronic component in a motor.

21. A neodymium-iron-boron magnet material, wherein, the neodymium-iron-boron magnet material comprises the following components by mass percentage: 29.4-32.6% of R′, R′ comprises Pr and Nd; wherein, Pr≥17.14%;
Cu≥0.34%;
0.9-1.2% of B;
64-69.2% of Fe;
the percentage refers to the mass percentage relative to the total mass of the neodymium-iron-boron magnet material.

22. The neodymium-iron-boron magnet material according to claim 21, wherein, the content of Pr is 18.15-26.1%;
or, the ratio of the mass of Nd to the total mass of R′ is less than 0.5.

23. The neodymium-iron-boron magnet material according to claim 21, wherein, R′ further comprises RH, RH is a heavy rare earth element, the kind of RH comprises one or more of Dy, Tb and Ho; the mass ratio of RH and R′ is preferably less than 0.253; wherein, the content of RH is 1-2.5%.

24. The neodymium-iron-boron magnet material according to claim 21, wherein, the content of Cu is 0.34-1.3%.

25. The neodymium-iron-boron magnet material according to claim 21, wherein, the neodymium-iron-boron magnet material further comprises Al; the content of Al is 0.5% or less;
or, the neodymium-iron-boron magnet material further comprises Zr; the content of Zr is 0.05-0.31 wt. % by weight;
or, the neodymium-iron-boron magnet material further comprises Ga; the content of Ga is 0.51% or less;
or, the neodymium-iron-boron magnet material further comprises Co; the content of Co is 0.2-1.5%;
or, the neodymium-iron-boron magnet material further comprises 0; the content of O is 0.13% or less;
or, the neodymium-iron-boron magnet material may further comprise one or more of Zn, Ag, In, Sn, V, Cr, Mo, Ta, Hf and W.

26. An application of the neodymium-iron-boron magnet material according to claim 21 as an electronic component in a motor.

27. A neodymium-iron-boron magnet material, wherein, in the intergranular triangle region of the neodymium-iron-boron magnet material, the ratio of the total mass of Pr and Cu to the total mass of each element in the intergranular triangle region is Q1;
at the grain boundary of the neodymium-iron-boron magnet material, the ratio of the total mass of Pr and Cu to the total mass of each element at the grain boundary is Q2;
wherein, Q1<Q2, and Q2≥0.1.

28. The neodymium-iron-boron magnet material according to claim 27, wherein, the neodymium-iron-boron magnet material comprises the following components by mass percentage: 29.4-32.6% of R′, R′ comprises Pr and Nd; wherein, Pr≥17.14%;
Cu≥0.34%;
0.9-1.2% of B;
64-69.2% of Fe;
the percentage refers to the mass percentage relative to the total mass of the neodymium-iron-boron magnet material.

29. An application of the neodymium-iron-boron magnet material according to claim 27 as an electronic component in a motor.
